(19) United States
(12) Patent Application Publication
(10) Pub. No.: US 2026/0276508 A1
(43) Pub. Date: Sep. 17, 2026

(54) VISCOSITY AND SURFACE TENSION MEASUREMENT USING RESONANCE OF LEVITATED DROPLETS

(71) Applicant: University of Florida Research Foundation, Inc., Gainesville, FL (US)

(72) Inventors: Ranganathan Narayanan, Gainesville, FL (US); Thomas Corbin, Gainesville, FL (US); Jason D. Livesay, Gainesville, FL (US); Robert Singiser, Gainesville, FL (US); Michael SanSoucie, Gainesville, FL (US); Brandon Phillips, Gainesville, FL (US)

(21) Appl. No.: 19/676,649

(22) Filed: May 13, 2026

Related U.S. Application Data
(63) Continuation-in-part of application No. PCT/US2024/056187, filed on Nov. 15, 2024.
(60) Provisional application No. 63/600,376, filed on Nov. 17, 2023.

(51) Int. Cl. G01N 11/00; G01N 1/44; G01N 13/02; G06T 7/00

(52) U.S. Cl. CPC G01N 11/00; G01N 1/44; G01N 13/02; G06T 7/0004; G01N 2011/0073; G06T 2207/30108

(57) ABSTRACT

Various examples are provided related to measurement of viscosity and surface tension in levitated liquid droplets. In one example, a method includes levitating a sample using electrostatic levitation; determining a measured resonance frequency of the sample by an analysis of a plurality of captured images, the measured resonance frequency based upon a maximum response deviation of the levitated sample at a mode of oscillation; determining a decay constant of the sample associated with the measured resonance frequency; and determining a viscosity of the sample based at least in part upon the decay constant of the sample. In another example, a system includes electrodes; a position sensor; and a camera device. A computing device can cause the system to levitate a sample using the method or variations thereof.

### CROSS REFERENCE TO RELATED APPLICATIONS

This application is a continuation-in-part of PCT Application No. PCT/US2024/056187, filed Nov. 15, 2024, which claims priority to, and the benefit of, U.S. provisional application entitled “Viscosity and Surface Tension Measurement Using Resonance of Levitated Droplets” having Ser. No. 63/600,376, filed Nov. 17, 2023, both of which are hereby incorporated by reference in their entireties.

### STATEMENT REGARDING FEDERALLY SPONSORED RESEARCH OR DEVELOPMENT

This invention was made with government support under Grant Number 2025117 awarded by the National Science Foundation, and Grant Numbers 80NSSC20M0093 and NNX17AL27G awarded by the National Aeronautics & Space Administration. The government has certain rights in this invention.

This invention was supported by the National Aeronautics & Space Administration through the University of Central Florida's NASA Florida Space Grant Consortium.

### BACKGROUND

The accurate measurement of thermophysical properties is imperative for the future of countless areas of manufacturing and extends its importance into space exploration with the recent push for the Lunar Gateway, in-space manufacturing, and in-situ resource utilization. The reliability of processes like crystal growth, additive manufacturing, and welding depend on precise knowledge of thermophysical phenomena. However, thermophysical property measurement of high-temperature materials like liquid metals, glasses, and oxides is difficult using conventional means because of high surface reactivity. The advent of containerless materials processing using aerodynamic, acoustic, electromagnetic, and electrostatic levitation technologies have provided an avenue for further improvements in the accuracy of thermophysical property measurements and can also be used to provide insights into other important material behavior like phase equilibria and solidification dynamics. Surface tension, a notably important property, can be measured using levitation technologies by exploiting the natural frequency fₙ at which a spherical liquid droplet comes to rest, given by:

$${f}_{n} = \sqrt{\frac{n ( n - 1 ) ( n + 2 ) γ}{3 π M}} \qquad ( 1 )$$

where γ is the surface tension, n is the normal mode of oscillation and M is the mass. By experimentally finding the natural frequency fₙ, one can solve Equation 1 for surface tension. Electrostatic levitation holds several advantages to other levitation techniques. Aerodynamic and acoustic levitation both require the presence of a fluid medium, which can present engineering challenges like contamination, viscous effects, and large deviations in the spherical base state. Electromagnetic levitation experiments take place in vacuum but also suffer from the issue of asphericity. The non-spherical nature of the droplet causes its frequency response to split degenerate n=2 modes into separate frequencies. However, in electrostatic levitation, experimental observations have found that the droplet is significantly more spherical than other levitation techniques, often resulting in single frequency response. Faraday forcing uses electrostatic levitation as a means to measure surface tension.

The Faraday forcing method in levitated liquid droplets has recently been introduced as a method for measuring surface tension using resonance. By subjecting an electrostatically-levitated liquid metal droplet to a continuous, oscillatory, electric field, at a frequency nearing that of the droplet's first principal mode of oscillation (known as mode 2), the method was previously shown to determine surface tension of materials that would be particularly difficult to process by other means, e.g. liquid metals and alloys. It also offered distinct advantages over the conventional levitation-based method of pulse-decay, particularly for high viscosity samples, avoiding undesirable control system perturbations to the sample upon pulse-release.

### SUMMARY

Aspects of the present disclosure are related to measurement of viscosity and surface tension in levitated liquid droplets. In one aspect, among others, a method comprises levitating a sample using electrostatic levitation; determining a measured resonance frequency of the sample by an analysis of a plurality of captured images of the sample, the measured resonance frequency based upon a maximum response deviation of the levitated sample at n=3 mode of oscillation, wherein the measured resonance frequency is a particular frequency associated with sample resonance; determining a decay constant of the sample associated with the measured resonance frequency; and determining a viscosity of the sample based at least in part upon the decay constant of the sample. The method can further comprise determining a surface tension of the sample based on the measured resonance frequency of the sample at n=3 mode of oscillation. The method can further comprise determining a measured resonance frequency of the sample at n=4 mode of oscillation; and determining a surface tension of the sample at least in part based on the measured resonance frequency of the sample at n=4 mode of oscillation.

In one or more aspects, determining the measured resonance frequency of the sample can comprise: applying a signal to at least one electrode, wherein the signal excites the sample into the n=3 mode of oscillation, the signal is swept over a range of frequencies that includes a predetermined frequency; capturing the plurality of captured images of the sample using a camera device, a respective image of the plurality of images being associated with a particular frequency that is applied to the sample when the respective image is captured; quantifying, using at least one computing device, a plurality of sample resonance using a projection method of Legendre polynomials based on the plurality of captured images, a respective sample resonance being associated with a respective image and a particular frequency that is applied to the sample when the respective image is captured; and determining, using the at least one computing device, the measured resonance frequency of the sample by the analysis of the plurality of sample resonance that indicates that the respective sample resonance shows a maximum response deviation of the levitated sample, wherein the measured resonance frequency is the particular frequency that is associated with the respective sample resonance. The predetermined frequency can be a predicted resonance frequency determined using a formula that relates frequency to spherical radius, density, and surface tension of the sample. The signal can be a sinusoidal signal. The method can further comprise melting the sample into a liquid state using a heating laser once the sample is levitated. The sample can be maintained at a substantially constant temperature by the heating laser based upon a monitored temperature of the sample.

In another aspect, a system comprises a plurality of electrodes; a position sensor; a camera device; and at least one computing device that executes instructions that cause the system to at least: levitate a sample using a feedback-controlled voltage applied to at least one of the plurality of electrodes, wherein the feedback-controlled voltage is determined based at least in part on a position of the sample that is detected by the position sensor; determine a measured resonance frequency of the sample by an analysis of a plurality of images of the sample captured with the camera device, the measured resonance frequency based upon a maximum response deviation of the levitated sample at n=3 mode of oscillation, wherein the measured resonance frequency is a particular frequency associated with sample resonance; determine a decay constant of the sample associated with the measured resonance frequency; and determine a viscosity of the sample based at least in part upon the decay constant of the sample. In one or more aspects, the at least one computing device can further execute instructions that cause the system to determine a surface tension of the sample using the measured resonance frequency at n=3 mode of oscillation. The at least one computing device can further execute instructions that cause the system to determine a measured resonance frequency of the sample at n=4 mode of oscillation; and determine a surface tension of the sample at least in part based on the measured resonance frequency of the sample at n=4 mode of oscillation.

In various aspects, determining the measured resonance frequency of the sample can comprise: applying a signal to at least one electrode, wherein the signal excites the sample into the n=3 mode of oscillation, the signal is swept over a range of frequencies that includes a predetermined frequency; capturing the plurality of captured images of the sample using a camera device, a respective image of the plurality of images being associated with a particular frequency that is applied to the sample when the respective image is captured; quantifying, using at least one computing device, a plurality of sample resonance using a projection method of Legendre polynomials based on the plurality of captured images, a respective sample resonance being associated with a respective image and a particular frequency that is applied to the sample when the respective image is captured; and determining, using the at least one computing device, the measured resonance frequency of the sample by the analysis of the plurality of sample resonance that indicates that the respective sample resonance shows a maximum response deviation of the levitated sample, wherein the measured resonance frequency is the particular frequency that is associated with the respective sample resonance. The predetermined frequency can be a predicted resonance frequency determined using a formula that relates frequency to spherical radius, density, and surface tension of the sample. The signal can be a sinusoidal signal. The system can further comprise a heating laser that melts the sample into a liquid state using a heating laser once the sample is levitated. Operation of the heating laser can be controlled to maintain the sample at a substantially constant temperature. The system can comprise a temperature sensor configured to monitor temperature of the levitated sample.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a simplified schematic illustrating an example of a system used to measure viscosity and/or surface tension in levitated materials, in accordance with various aspects of the present disclosure.

FIGS. 2A and 2B illustrate an example of determination of resonant mode frequencies of the levitated material, in accordance with various aspects of the present disclosure.

FIG. 3 is a schematic diagram illustrating an example of a system for measuring viscosity and/or surface tension of a levitated sample, in accordance with various aspects of the present disclosure.

FIGS. 4A and 4B includes images illustrating examples of resonant modes of Tin samples, in accordance with various aspects of the present disclosure.

FIG. 5 illustrates examples of the projection method of modes 2 and 3, in accordance with various aspects of the present disclosure.

FIGS. 6A and 6B illustrate examples of dynamic projection amplitude as a function of time and FFT amplitudes, in accordance with various aspects of the present disclosure.

FIGS. 7A and 7B illustrate examples of results from the benchmarking of Faraday forcing method, in accordance with various aspects of the present disclosure.

FIGS. 8A-8C illustrate examples of results demonstrating decay of modes higher than mode 2 in a tin (Sn) sample, in accordance with various aspects of the present disclosure.

### DETAILED DESCRIPTION

Many modifications and other embodiments disclosed herein will come to mind to one skilled in the art to which the disclosed systems and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise.

The term “interfacial tension” and “surface tension” are used interchangeably herein, which refer to the tension between the sample and phase surrounding the sample. For example, the sample can be in a liquid state, and its surroundings can be in a gaseous state, such as air or another gas. The sample can include liquid metals, semiconductors, liquid ceramics, liquefied glass, common liquids, and other materials.

The present disclosure generally relates to measurement of viscosity and surface tension in levitated liquid droplets. The use of resonance to measure the viscosity and surface tension in levitated liquid droplets is presented and builds upon work on the natural frequencies of a liquid sphere. The Faraday forcing method, has applications particularly in property measurement of high temperature liquid metals, for use in advanced material processing in space. A droplet is electrostatically levitated, melted, and subjected to electric field oscillations at different frequencies which cause the droplet to deform. As the electric field oscillation frequency approaches one of the natural frequencies of the droplet, the strength of deformation hits a maximum. The procedure systematically finds the lowest two, three, or four natural frequencies of the levitated liquid droplets and uses the results to calculate surface tension and viscosity for that material. In the following disclosure, the methodology of processing the droplet is presented with a focus on the benchmarking process using multiple modes of oscillation.

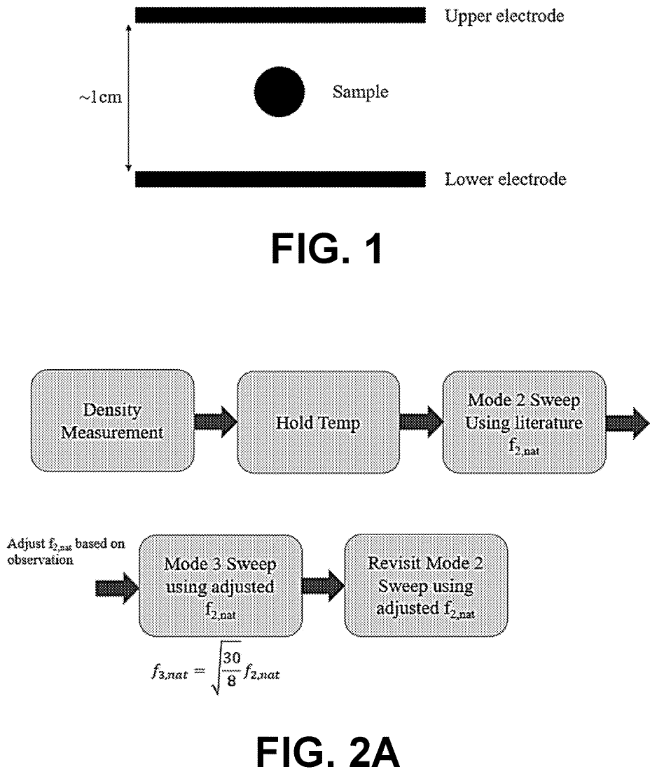

Generally, the systems and methods involve the electrostatic levitation of a droplet in the liquid state. The droplet can be spherical when levitated. The droplet can be levitated when already in the liquid state, or levitated as a solid sphere and then melted using a laser or furnace. As illustrated in FIG. 1, levitation can be achieved through a feedback controlled voltage drop between two electrodes located on either pole of the droplet, creating a Coulomb Force on the droplet which acts counter to gravity. An upper and lower electrode can be connected to a control system that can track the position of the droplet. After successful levitation, the droplet can be continuously perturbed or forced by applying an additional sinusoidal voltage on the top electrode with an input frequency and amplitude. Upon melting the sample, an oscillatory electric filed can be superimposed on the control voltage to cause the droplet deformations. The amplitude of oscillation can be held constant, and the frequency can be swept over a large range which includes the predicted frequency that resonates with the natural frequency of the material, given by the theory of Rayleigh. The predicted frequency can be predetermined and, for example, stored in a memory. The droplet is viewed with a high-speed camera and the shape of the droplet is recorded through the entire frequency sweep. For example, each image can have a timestamp. In addition, separate videos can be made for each forcing frequency, and these videos can be so labeled. Accordingly, a respective image can be associated with both the time and frequency, for example, using the image data that includes the frequency label for the video and the timestamp for the image. Alternatively, a single or continuous video can be made that includes multiple frequencies. Also, each frame or image can be directly associated with both a frequency label or frequency stamp and a timestamp. The camera can, in some examples be 500 fps or higher, 1000 fps or higher, 2500 fps or higher, or 5000 fps or higher. The camera can include any resolution but can in some cases be 512×512 pixels or higher, 1024×1024 pixels or higher, or another resolution or another aspect ratio.

After recording, the images can be analyzed to determine which forcing frequency resulted in the largest disturbance of the levitated droplet away from a spherical shape. The imposed oscillatory voltage will cause the droplet to undergo cycles of prolate and oblate ellipsoidal shapes, with the magnitude of the departure from a spherical shape increasing as the imposed frequency nears the natural frequency and resonates with it. This resonance frequency is taken to be the forcing frequency that causes the largest disturbance from spherical, and because it is equal to the natural frequency of the drop, it allows one to deduce the interfacial tension of the material, for example, using Rayleigh Theory. In one embodiment, the sample resonance/disturbance is quantified using a projection method of Legendre polynomials.

In some embodiments, a system includes a plurality of electrodes, a position sensor, a camera device, and at least one computing device that can be used to perform or execute instructions. A sample can be levitated using a feedback-controlled voltage applied to at least one of the plurality of electrodes. The feedback-controlled voltage can be determined based at least in part on a position of the sample that is detected by the position sensor. A heating laser can melt the sample into a liquid state once the sample is levitated. A signal can be applied to at least one of the plurality of electrodes. The signal can be a sinusoidal signal that comprises the fixed amplitude and is swept over the range of frequencies.

The signal can include a fixed amplitude. The fixed amplitude can be chosen as an amplitude that results in drop deviations from the spherical shape that are considerably smaller than the diameter of the drop. This signal can be swept over a range of frequencies that includes the natural frequency. The natural frequency is a formula that is related to the drop density, its, radius and its surface tension. Therefore, it determines the forcing frequency, which when equal to it resonates with it. In other words, the forcing frequency becomes the resonant frequency when it equals the natural frequency. A plurality of images of the sample can be captured using the camera device. A respective image of the plurality of images can be associated with a particular frequency that is applied to the sample when the respective image is captured. The plurality of images can be analyzed to determine that the particular frequency is the measured resonance frequency of the sample, based at least in part on the respective image showing a maximum response deviation of the levitated sample from its spherical shape. In other words, a measured resonance frequency of the sample can be determined or identified using an analysis of the plurality of images that indicates that the respective image shows a maximum response deviation of the levitated sample from its spherical shape, wherein the measured resonance frequency is the particular frequency that is applied to the sample when the respective image, which shows the largest departure from the sample's spherical shape, is captured. In one embodiment, the sample resonance/disturbance is quantified using a projection method of Legendre polynomials.

The maximum response deviation can be identified based at least in part on the respective image including a maximum distance across the sample, among the plurality of images. In some cases, the maximum distance can be measured across a major axis of a prolate shape of the sample shown in the respective image. In other cases, the maximum distance is measured across an axis of an oblate shape of the sample shown in the respective image. Viscosity and/or surface tension of the sample can be determined using the measured resonance frequency.

In some embodiments, a method can be performed, which can be a computer-implemented method. The method can include levitating a sample using a feedback-controlled voltage applied to at least one of a plurality of electrodes. The feedback-controlled voltage can be determined based at least in part on a position of the sample that is detected by a position sensor. In some cases, the sample can be melted into a liquid state using a heating laser once the sample is levitated.

The method can also include applying a continuous signal to at least one of the plurality of electrodes. The signal can include a fixed amplitude and can be swept over a range of frequencies that includes a predetermined frequency. The signal can be a sinusoidal signal swept over a range of frequencies that includes a predetermined frequency. The predetermined frequency can be a predicted natural frequency determined using Rayleigh theory. The method can further include capturing a plurality of images of the sample using a camera device, a respective image of the plurality of images being associated with a particular frequency that is applied to the sample when the respective image is captured.

The method can further include identifying a measured resonance frequency of the sample by an analysis of the plurality of images that indicates that the respective image shows a maximum response deviation of the levitated sample from its spherical shape, wherein the measured resonance frequency is the particular frequency that is applied to the sample when the respective image is captured. The maximum response deviation can be identified based at least in part on the respective image including a maximum distance across the sample, among the plurality of images. In some cases, the maximum distance can be measured across a major axis of a prolate shape of the sample shown in the respective image. In other cases, the maximum distance can be measured across an axis of an oblate shape of the sample shown in the respective image. The method can also include determining viscosity and/or surface tension of the sample using the measured resonance frequency.

To calculate viscosity and surface tension based on the experimentally determined resonant frequencies and on their decay for droplets in modes n=2, n=3 and n=4, the equation given by Rayleigh can be used. Solving for surface tension, this equation is:

$$γ = \frac{3 π M {f}_{nat}}{n ( n + 2 ) ( n - 1 )} \qquad ( 2 )$$

where fₙₐₜ is the experimentally determined natural frequency in Hz for a drop of mass, M, for either mode n=2, n=3 or higher modes. Solving for viscosity, the equation to be used is:

$$η = \frac{{pr}_{0}^{2}}{( n - 1 ) ( 2 n + 1 ) {τ}_{n}} \qquad ( 3 )$$

where ρ is the density, r₀ is the drops rest radius, and τₙ is the decay constant as the drop comes to rest from any of its model shapes.

Samples can be levitated as a solid using an electrostatic position feedback system, which can control both vertical and horizontal positioning. For example, the levitation chamber can first be evacuated using a turbomolecular pump to 10-7 torr. Electric charge can then be applied to the sample with a UV beam and replenished, if needed, throughout processing. The sample is melted using, e.g., a fiber optic laser and superheated to approximately 50° C. above the melting point (in the case of a metal such as Zr) and allowed to radiatively cool to solidification to record density measurements. A single wavelength pyrometer (Advanced Energy IMPAC IGA 140) can be used to measure the temperature within a range of about 300° C. to about 3000° C.

In surface tension measurements, the sample is melted and then subcooled below the melting point (if possible) to minimize evaporation. Upon reaching the desired temperature, the laser is used to maintain constant temperature. A waveform generator and amplifier can be connected to the upper electrode to allow the user to impose an oscillatory electric field. Droplet behavior is characterized with a high-speed camera at, e.g., 5000 fps and 512 by 512 pixels, typically for durations of, e.g., 1-1.5 s. The sample is weighed both before and after processing to quantify evaporation.

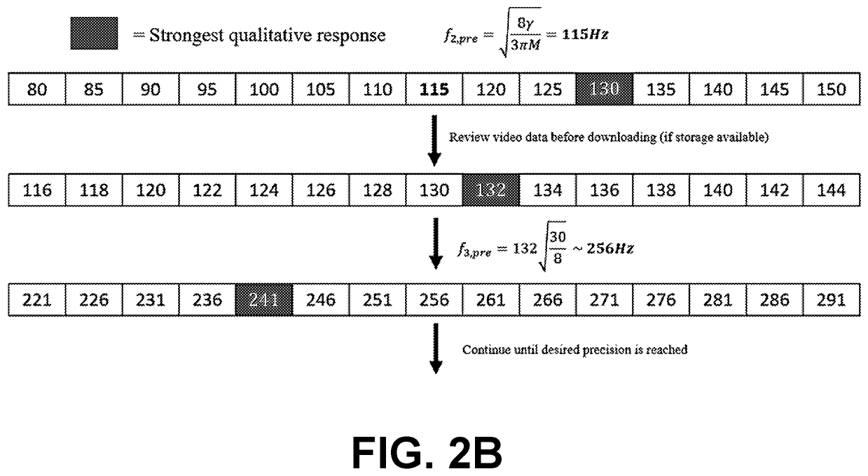

The natural frequencies for modes n=2, n=3 and n=4 are initially predicted using the droplet's mass and accepted literature surface tension value with equation 2. Modes 2, 3 and 4 can be discovered using a method known as a frequency sweep. The overall procedure for systematically finding the resonant point for these modes is illustrated in FIG. 2A, with an example set of sweeps shown in FIG. 2B. An example of a standard protocol for collecting mode 2 and mode 3 video data is illustrated. A natural frequency for mode 2 can be predicted using literature values and a frequency range and step size can be selected. The preliminary results from mode 2 (prior to image analysis) from qualitative observation can be used to refine the sweep to finer frequency steps. Results from mode 2 sweeps can then be used to predict the occurrence of mode 3 based on the Rayleigh formula. This procedure can be repeated until the desired precision is reached.

For each frequency of a frequency sweep, an oscillatory voltage (known as a forcing frequency) is applied to the top and/or bottom electrodes for 1-2 s. Upon completion of each forcing frequency, the oscillatory voltage is turned off and the droplet's deformations can come to rest before starting the next forcing frequency (typically 1 s). The sweep can be centered about the predicted natural frequency and, depending on confidence level, the step size (difference between one forcing frequency and the next) can be in a range of about 0.5-5 Hz, with, e.g., 20-30 total frequencies tested. For example, the mode 2 natural frequency of a 35.027 mg Zirconium sample at 1800° C. is predicted to be 185 Hz, so the sweep can encompass frequencies ranging between 170-200 Hz, taking steps of 1 Hz. After finishing the mode 2 frequency sweep, the droplet remains levitated but can be solidified to suppress evaporation. The videos from the high-speed camera are previewed after the sweep prior to download and resonance is characterized by eye before beginning the mode 3 sweep.

FIG. 2B shows an example of a sweep protocol for determining the natural frequency for modes n=2 and n=3 when the surface tension is known from literature sources, including the forcing frequencies for each sweep. The observance of n=2 is used to guide the search for n=3 because it is typically easier to observe. In the example of FIG. 2B, the natural frequency for mode 2 is initially predicted as f_{2,pre}=115 Hz, but the resonant excitation initially identified the strongest response at 130 Hz, which was subsequently refined to 132 Hz. Using this value, the natural frequency for mode 3 is initially predicted as f_{3,pre}=241 Hz, but the resonant excitation initially identified the strongest response at 241 Hz, which can be further refined.

If there is no published data for the material of interest, multiple frequency sweeps can be performed to find the resonance point of mode 2. First, a broad sweep (e.g., 100-200 Hz) of large step size can be used to force the droplet to resonate in mode 2. Subsequent sweeps can follow with narrowing frequency range and decreasing step size until the desired accuracy is achieved.

The fashion in which the mode 3 sweep is conducted depends on the preliminary results from the mode 2 sweep. If there is conclusive video evidence that the mode 2 sweep yielded strong resonance at a certain frequency (known as f₂), the mode 3 sweep will be centered on its corresponding mode 3 frequency. This corresponding mode 3 frequency, given by Equation (3), is \sqrt{30/8}f₂. The value of f₂ may be different than the predicted natural frequency from literature values. If there is no conclusive video evidence of resonance, the frequency sweep for mode 3 can be chosen in accordance to accepted literature values, if they exist. If there are no published data for the material and no conclusive video of mode 2 is observed, mode 3 can be sought using a progressively narrowing set of frequency sweeps, identical to the fashion in which mode 2 is sought. The sample can be remelted, subcooled (if possible), and the mode 3 frequency sweep can be conducted, taking steps of 0.5-5 Hz. This procedure can then continue to higher modes.

To determine the decay constants for each mode, the AC voltage forcing for a given mode is ceased for that mode. The drop gradually comes to rest. The images of the decaying drop can be analyzed to determine the decay time constants and inserted into Equation (3) to determine the viscosity. A self-consistent method to determine viscosity would need that the viscosity inferred from the decay constant for mode 2 should be the same for all subsequent modes. All videos are processed and subsequently analyzed using ImageJ to obtain the droplet shadow area and outline as a function of time. Mathematica can be used in the batch processing of the projection method and evaporation quantification. The forcing frequency which yields the highest magnitude of resonance for a given frequency sweep is termed the resonant frequency and plugged into Equation (3) to calculate surface tension.

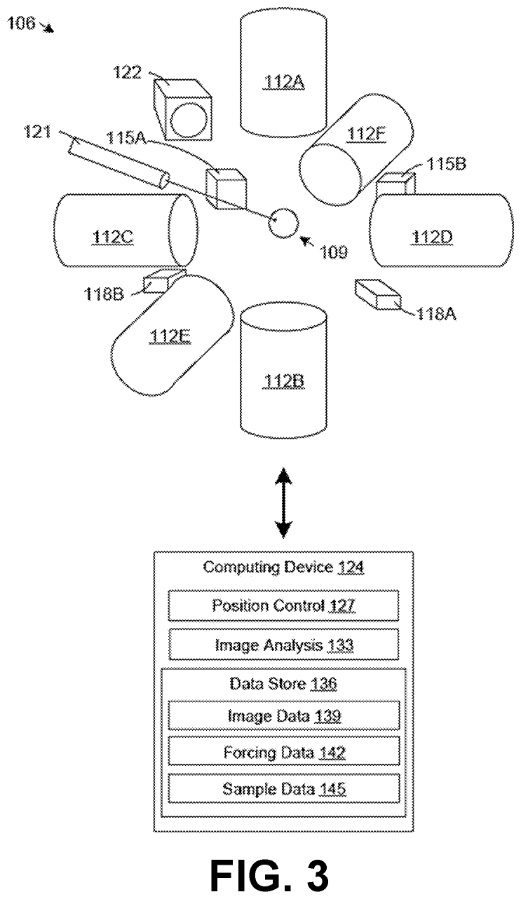

FIG. 3 illustrates a system 106 that can be used for the measurement of viscosity and/or surface tension of a sample 109. The sample 109 can be suspended using electrostatic levitation. Electrostatic levitation of the sample 109 can be achieved using a number of electrodes 112, including the electrodes 112A, 112B, 112C, 112D, 112E, and 112F. The system can also include position sensor 115, including position sensors 115A and 115B, and in some cases the corresponding backlights 118A and 118B, which can in some case be laser-based backlights or other backlights designed for the sensors 115A and 115B. A laser 121 can be used to heat and melt the sample 109. A camera 122, such as a high speed camera, can be used to capture images of the sample 109 throughout the procedure. While excluded from the figure for clarity, an ultraviolet lamp can be used to impart a charge to the sample 109, and a temperature sensor such as a pyrometer, infrared thermometer, or the like can be used to detect a temperature of the sample 109. The temperature data from the temperature sensor can be used to control the laser 121 or other heating apparatus such as a furnace, to maintain the sample 109 at a target temperature. In some cases, the target temperature can be chosen to ensure the sample 109 is in a liquid state.

These devices can each be communicatively connected with a computing device 124, which can be representative of a single computing device 124 or multiple computing devices 124 to facilitate or perform the various actions described individually or in combination, for the measurement of viscosity and/or surface tension of the sample 109. The computing device 124 can in some cases execute instructions such as, position control functionality 127 and image analysis functionality 133, among other instructions. Each of these functionalities can be embodied in applications, programs, or other instructions, and can be executed by the computing device 124. In some examples these functionalities can be directed or performed by a user and can be facilitated by the computing device 124, and in other cases these functionalities can be automated or performed by the computing device 124.

A data store 136 communicatively connected with the computing device 124 can store the instructions, including the position control functionality 127 and the image analysis functionality 133, among other instructions. The data store 136 can further store image data 139, pulsing data 142, and sample data 145, and other data.

A voltage can be applied to at least one of the electrodes 112 to cause an electrostatic field that levitates the sample 109. For example, when the sample is levitated as shown in FIG. 1, a voltage can be applied to at least one of the electrodes 112A or 112B to maintain an electrostatic field that can levitate the sample 109. The voltage that is applied to the electrode 112A, 112B, or both the electrodes 112A and 112B, can cause a feedback controlled voltage drop across the electrodes 112A or 112B that can counteract gravity, thereby levitating the sample 109. Because these electrodes are located above and below the sample 109, the voltage drop can be used to counteract forces in the vertical direction such as gravity. The electrodes 112C, 112D, 112E, and 112F are situated lateral to sample 109, and can be used to move the sample 109 laterally, for example, to maintain its lateral position, by applying voltage to the respective electrodes.

The position sensor 115 can be utilized to detect the position of the sample 109, which can be continuously monitored in order to maintain a target position for the sample 109. The position sensor 115 can include multiple position sensors such as the position sensors 115A and 115B, such that the position of the sample 109 can be monitored and maintained in three dimensions. In some cases, position sensor 115A can include or be used in conjunction with the corresponding backlight 118A. Position sensor 115B can likewise include or be used in conjunction with the backlight 118B. The position control functionality 127 can receive position data from the position sensor 115, and can apply a feedback controlled voltage to any of the electrodes 112, or any subset of the electrodes 112 to levitate the sample 109.

While shown in one particular arrangement in the figure, the electrodes 112 can be positioned in other arrangements to maintain the that levitate the sample 109. For example, another arrangement could have eight electrodes, each positioned at the corners of an imaginary box shape, or other arrangements. Nevertheless, the position control functionality 127 can use position data from the position sensor 115 to apply a feedback controlled voltage to any one of the electrodes, or any subset of the electrodes in various arrangements, as required to levitate the sample 109 and maintain its position.

The laser 121 can be used to heat and melt the sample 109. The sample 109 can be levitated when already in the liquid state, or levitated as a solid sphere and then melted using the laser 121. While one laser 121 is shown, multiple such lasers 121 can be used to melt the sample 109 into a liquid state, and to maintain a target temperature, for example, using feedback data from a temperature sensor. In some cases, this can be performed through a temperature control functionality of the computing device 124, and stored in the data store 136. Alternatively, a furnace can be used for heating the sample 109 into a liquid state.

An additional signal can be applied to any one of the electrodes 112, or a subset of the electrodes 112 to pulse the sample. In other words, applying the signal can disrupt the levitated sample 109 and cause it to vibrate or oscillate. The vibration can deform the sample 109, disturbing it from a spherical shape into prolate and oblate shapes. When the sample 109 is vibrated at its resonance frequency, the sample 109 can reach a maximum disturbance from a spherical shape.

The range of frequencies can include a predicted resonance frequency of the sample 109. The predicted resonance frequency can, for example, be determined using the theory of Rayleigh or can be another established or expected value, which can be stored in the data store 136, for example, in the pulsing data 142. The pulsing data 142 can also include the range of frequencies to be swept, and the amplitude of the signal, and other signal data such as a rate of change of the frequency sweep, a total duration in time of the signal, and particular times that are associated with particular frequencies in the signal. Particular frequencies are not limited to whole-number frequencies and can indicate any level of specificity, including fractional or decimal values.

The camera 122 can capture images of the sample as the frequency is swept across the range of frequencies, and store them in the image data 139. Accordingly, each frame of a video feed, or each image that is captured, can be associated with the particular frequency that is applied to the sample 109 when the image or the frame is captured. In some cases, multiple images can be associated with a same particular frequency. A shape of the sample 109 can be analyzed in each image or frame. A particular one of the images of the image data 139 can show a maximum disturbance of the levitated sample 109, or a maximum deviation from a spherical shape. Once the image that shows the maximum disturbance of the sample 109 is identified through the analysis, the frequency of the sweep that was applied when the image was captured can be identified. This frequency can be considered a measured resonance frequency of the sample 109, and can be stored in the sample data 145.

The maximum disturbance can be determined in a number of ways. For example, each image can be angled, and a distance can be measured across a major axis of a prolate shape of the sample 109 shown in each image. A particular image can show a maximum distance across a major axis of a prolate shape. In other cases, the maximum distance can be measured across an axis of an oblate shape of the sample 109 shown in the respective image. Alternatively, an image can be identified that has a maximum or minimum vertical size of the sample 109, a maximum or minimum horizontal size of the sample 109, or another maximum or minimum measure of the sample 109 can be identified.

In another embodiment, sample resonance may be quantified using a projection method of Legendre polynomials based on the captured sample image. A measured resonance frequency of the sample 109 may be determined by an analysis of a plurality of quantified sample resonance that indicates that the respective quantified sample resonance shows a maximum response deviation of the levitated sample, wherein the measured resonance frequency is the particular frequency that is associated with the respective sample resonance.

The measured resonance frequency of the sample 109 is related to the interfacial tension of the sample 109. A calculation can be performed to determine the viscosity and/or surface tension of the sample 109 using the measured resonance frequency. The calculated viscosity and/or surface tension is based on the measured resonance frequency and can be considered a measured viscosity and/or surface tension. The measured viscosity and/or surface tension can be stored in the sample data 145.

### EXPERIMENTAL RESULTS

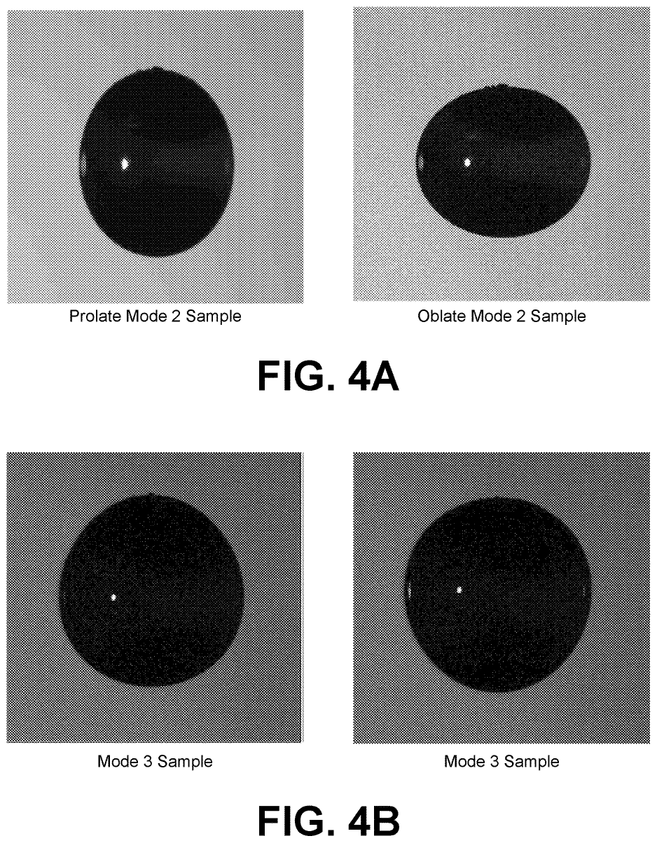

Experiments were conducted using the Electrostatic Levitation Facility (ESL) at NASA Marshall Space Flight Center (MSFC). The metals studied included Tin (Sn), Zirconium (Zr), and Indium (In). The maximum resonant frequencies and decay characteristics were found for modes n=2, 3, and 4 using the experimental method discussed previously. FIGS. 4A and 4B are images of examples of modes n=2 and n=3 for UFL-368 and UFL-379 Tin samples of 40.09 mg and 50.46 mg, respectively. The images shown are single frames from high speed videos demonstrating the deflection observed when a molten spherical sample is forced at its resonant frequency for a given mode.

### Projection Method of Resonance Quantification

The method in which resonance is quantified is termed herein as the projection method, where Legendre polynomials corresponding to each mode's precise shape (as defined by Rayleigh and often employed as a means of quantifying spherical deformations using image analysis) are projected on to the outline of the droplet. While this method returns the same results for mode 2 as the method outlined in Brosius et al, it is more consistently used for both modes 2 and 3 and thus serves as a more robust quantification of resonance, which can be used for any axisymmetric deformation. In the absence of external forces and in the limit of low viscosity, deformations on a spherical surface can be described by

$$r ( θ , ϕ , t ) = {R}_{0} + {\sum }_{n = 2}^{∞} {\sum }_{m = - n}^{n} {A}_{n}^{m} {e}^{im θ} {P}_{n}^{m} ( cos ( θ ) ) cos ( 2 π {f}_{n} t ) {e}^{\frac{- t}{{τ}_{n}}} \qquad ( 4 )$$

where R₀ is them resting radius of the sphere,

$${A}_{n}^{m}$$

are deformation amplitudes, τₙ is the decay constant,

$${P}_{n}^{m}$$

are the associated Legendre polynomials, n is a normal mode of oscillation, m represents degenerate modes of n, and fₙ is given by Equation (3). In the case of constant forcing,

$${e}^{\frac{- t}{{τ}_{n}}} = 1 .$$

Experimental findings noted that a single axisymmetric mode (m=0 in Equation (4)) is preferentially excited compared to its non-axisymmetric counterparts (m=±1, ±2) when electrostatically levitated, meaning the droplet could be well-approximated by a simplified version of Equation (4).

$$r ( θ , t ) = {R}_{0} + {\sum }_{n = 2}^{∞} {A}_{n} {P}_{n} ( cos ( θ ) ) cos ( 2 π {f}_{n} t ) {e}^{\frac{- t}{{τ}_{n}}} \qquad ( 5 )$$

where Pₙ are the Legendre polynomials and fₙ remains the same. Charge and gravitational effects unique to electrostatic levitation are derived by Rayleigh. In this work, these effects amount to a correction factor to the natural frequency.

Starting with an outline of the droplet, which can be found through image analysis as a function r(θ, t), the function δᵣ(θ, t) is defined as the normalized difference between the outline and the resting radius of the droplet.

$$δ r ( θ , t ) = \frac{r ( θ , t )}{{R}_{0}} - 1 = {\sum }_{n = 2}^{∞} {a}_{n} {P}_{n} ( cos ( θ ) ) cos ( 2 π {f}_{n} t ) {e}^{\frac{- t}{{τ}_{n}}} \qquad ( 6 )$$

Note that aₙ are now normalized with respect to the resting droplet's radius, that is aₙ=Aₙ/R₀. Since the Legendre polynomials obey the relationship:

$${\int }_{0}^{π} {P}_{n} ( cos ( θ ) ) {P}_{m} ( cos ( θ ) ) sin ( θ ) d θ = \frac{2}{2 n + 1} {δ}_{mn} \qquad ( 7 )$$

one may find the temporal amplitudes, aₙ(t), by way of projection, that is:

$${α}_{n} ( t ) = {a}_{n} cos ( 2 π {f}_{n} t ) {e}^{\frac{- t}{{τ}_{n}}} = \frac{2 n + 1}{2} {\int }_{0}^{π} {P}_{n} ( cos ( θ ) ) δ r ( θ , t ) sin ( θ ) d θ \qquad ( 8 )$$

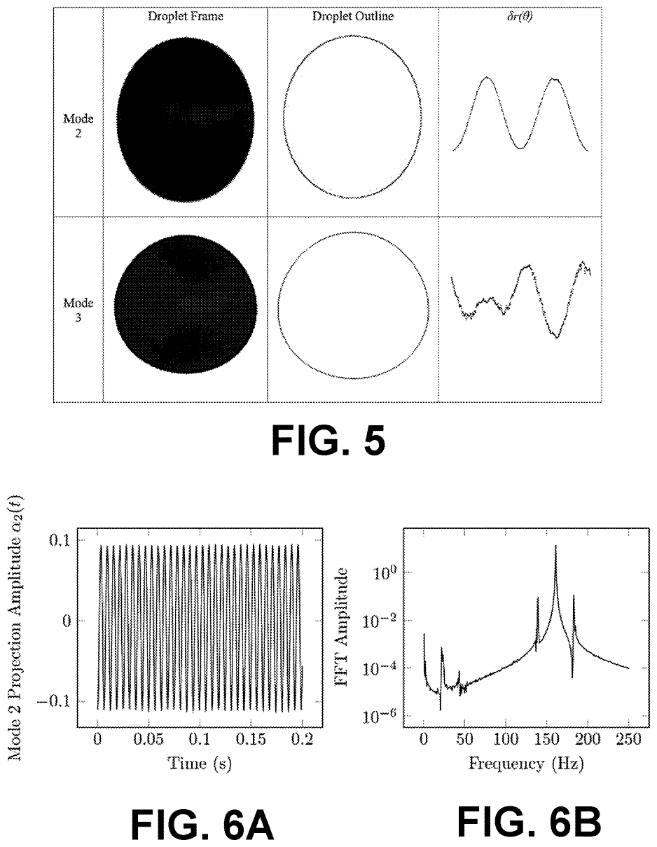

Using this definition of the projection amplitudes, one can therefore use the deformation outline δᵣ as obtained through image processing and perform a numerical integration scheme to quantify the amplitude of a given mode. The image analysis process is graphically illustrated in FIG. 5, which shows the projection method on mode 2 (top) and mode 3 (bottom). Performing this calculation for each frame of the video returns a graph of the dynamic projection amplitude α₂(t), as a function of time, like that shown in FIG. 6A for each forcing frequency. FIG. 6B shows the logarithmic representation of the FFT amplitudes of the dynamic projection amplitude.

Assuming sinusoidal behavior with total acquisition time T, one may assume the following relationship between the constant aₙ and the time-dependent data given by aₙ(t) when the number of oscillation cycles is large:

$${a}_{n} = \sqrt{2} {( \frac{{\int }_{0}^{T} {( {α}_{n} ( t ) )}^{2} dt}{{\int }_{0}^{T} dt} )}^{\frac{1}{2}} = \sqrt{2} {( \frac{1}{N} {\sum }_{i = 1}^{N} {a}_{n , i}^{2} )}^{\frac{1}{2}} \qquad ( 9 )$$

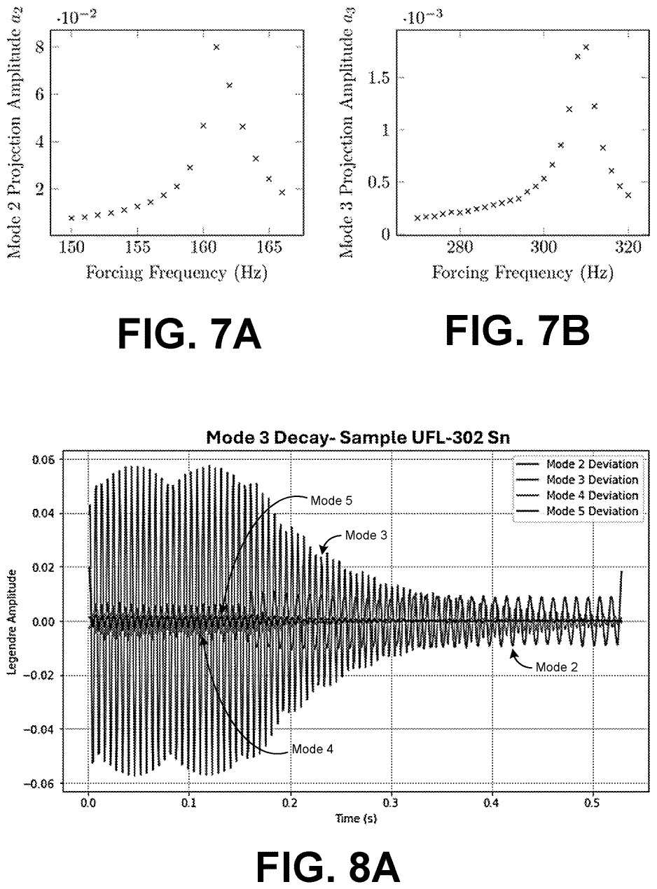

The resonant frequency for a given trial is taken to be the forcing frequency which resulted in the maximum resonance of the droplet in the prescribed modal shape (mode n=2 sweep shown in FIG. 7A or mode n=3 sweep shown in FIG. 7B). The sample was 57.345 mg Inconel 625 at 1350° C.

The same analysis technique solving for resonant frequency can be used to solve for the viscosity of the sample. The difference in the experimental method for viscosity measurements is as simple as ceasing the continuous forcing and recording high speed video as the droplet comes to rest. The image analysis is executed in the same way, observing a decrease in normalized amplitude. The decay constant can be extracted by relating this behavior to Equation (8). Multi-modal analysis can ensure self-consistent benchmarking for both surface tension and viscosity.

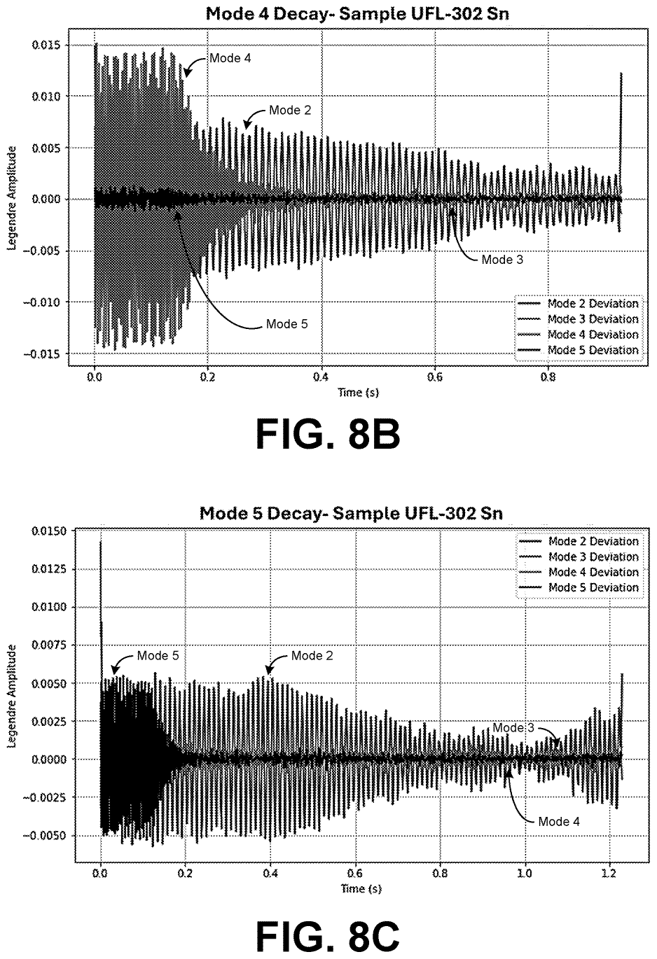

The method of Faraday forcing for the measurement of surface tension could be extended to resonance of higher order modes and an expanded array of materials such as glasses, oxides, and alloys. FIG. 8A illustrates an example of Legendre amplitude vs. time for a forced mode 3 tin sample (UFL-302). FIG. 8B illustrates an example of Legendre amplitude vs. time for a forced mode 4 tin sample (UFL-302). FIG. 8C illustrates an example of Legendre amplitude vs. time for a forced mode 5 tin sample (UFL-302). The graphs show the decay of the forced modes, from which viscosity can be extracted. Levitation experiments on the International Space Station which use an area array for sample monitoring can be effectively utilized in observing further benchmarking of the method using even harmonics. Space experiments can also be used to measure the surface tension of materials of high density such as Gold and Platinum which are difficult to electrostatically levitate on Earth.

It should be emphasized that the above-described aspects of the present disclosure are merely possible examples of implementations and are set forth only for a clear understanding of the principles of the disclosure. Many variations and modifications may be made to the above-described aspects of the disclosure without departing substantially from the spirit and principles of the disclosure. All such modifications and variations are intended to be included herein within the scope of this disclosure.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method, comprising:
levitating a sample using electrostatic levitation;
determining a measured resonance frequency of the sample by an analysis of a plurality of captured images of the sample, the measured resonance frequency based upon a maximum response deviation of the levitated sample at n=3 mode of oscillation, wherein the measured resonance frequency is a particular frequency associated with sample resonance;
determining a decay constant of the sample associated with the measured resonance frequency; and
determining a viscosity of the sample based at least in part upon the decay constant of the sample.

2. The method of claim 1, further comprising determining a surface tension of the sample based on the measured resonance frequency of the sample at n=3 mode of oscillation.

3. The method of claim 1, further comprising:
determining a measured resonance frequency of the sample at n=4 mode of oscillation; and
determining a surface tension of the sample at least in part based on the measured resonance frequency of the sample at n=4 mode of oscillation.

4. The method of claim 1, wherein determining the measured resonance frequency of the sample comprises:
applying a signal to at least one electrode, wherein the signal excites the sample into the n=3 mode of oscillation, the signal is swept over a range of frequencies that includes a predetermined frequency;
capturing the plurality of captured images of the sample using a camera device, a respective image of the plurality of images being associated with a particular frequency that is applied to the sample when the respective image is captured;
quantifying, using at least one computing device, a plurality of sample resonance using a projection method of Legendre polynomials based on the plurality of captured images, a respective sample resonance being associated with a respective image and a particular frequency that is applied to the sample when the respective image is captured; and
determining, using the at least one computing device, the measured resonance frequency of the sample by the analysis of the plurality of sample resonance that indicates that the respective sample resonance shows a maximum response deviation of the levitated sample, wherein the measured resonance frequency is the particular frequency that is associated with the respective sample resonance.

5. The method of claim 4, wherein the predetermined frequency is a predicted resonance frequency determined using a formula that relates frequency to spherical radius, density, and surface tension of the sample.

6. The method of claim 4, wherein the signal is a sinusoidal signal.

7. The method of claim 4, further comprising melting the sample into a liquid state using a heating laser once the sample is levitated.

8. The method of claim 7, wherein the sample is maintained at a substantially constant temperature by the heating laser based upon a monitored temperature of the sample.

9. A system, comprising:
a plurality of electrodes;
a position sensor;
a camera device; and
at least one computing device that executes instructions that cause the system to at least:
levitate a sample using a feedback-controlled voltage applied to at least one of the plurality of electrodes, wherein the feedback-controlled voltage is determined based at least in part on a position of the sample that is detected by the position sensor;
determine a measured resonance frequency of the sample by an analysis of a plurality of images of the sample captured with the camera device, the measured resonance frequency based upon a maximum response deviation of the levitated sample at n=3 mode of oscillation, wherein the measured resonance frequency is a particular frequency associated with sample resonance;
determine a decay constant of the sample associated with the measured resonance frequency; and
determine a viscosity of the sample based at least in part upon the decay constant of the sample.

10. The system of claim 9, wherein the at least one computing device further executes instructions that cause the system to determine a surface tension of the sample using the measured resonance frequency at n=3 mode of oscillation.

11. The system of claim 9, wherein the at least one computing device further executes instructions that cause the system to:
determine a measured resonance frequency of the sample at n=4 mode of oscillation; and
determine a surface tension of the sample at least in part based on the measured resonance frequency of the sample at n=4 mode of oscillation.

12. The system of claim 9, wherein determining the measured resonance frequency of the sample comprises:
applying a signal to at least one electrode, wherein the signal excites the sample into the n=3 mode of oscillation, the signal is swept over a range of frequencies that includes a predetermined frequency;
capturing the plurality of captured images of the sample using a camera device, a respective image of the plurality of images being associated with a particular frequency that is applied to the sample when the respective image is captured;
quantifying, using at least one computing device, a plurality of sample resonance using a projection method of Legendre polynomials based on the plurality of captured images, a respective sample resonance being associated with a respective image and a particular frequency that is applied to the sample when the respective image is captured; and
determining, using the at least one computing device, the measured resonance frequency of the sample by the analysis of the plurality of sample resonance that indicates that the respective sample resonance shows a maximum response deviation of the levitated sample, wherein the measured resonance frequency is the particular frequency that is associated with the respective sample resonance.

13. The system of claim 12, wherein the predetermined frequency is a predicted resonance frequency determined using a formula that relates frequency to spherical radius, density, and surface tension of the sample.

14. The system of claim 12, wherein the signal is a sinusoidal signal.

15. The system of claim 12, further comprising a heating laser that melts the sample into a liquid state using a heating laser once the sample is levitated.

16. The system of claim 15, wherein operation of the heating laser is controlled to maintain the sample at a substantially constant temperature.

17. The system of claim 16, comprising a temperature sensor configured to monitor temperature of the levitated sample.
